(19) United States
(12) Patent Application Publication
(10) Pub. No.: US 2006/0197426 A1
(43) Pub. Date: Sep. 7, 2006

(54) FIELD EMISSION LIGHTING DEVICE

(76) Inventor: Ga-Lane Chen, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/306,367

(22) Filed: Dec. 26, 2005

(30) Foreign Application Priority Data
Jan. 14, 2005 (TW) 094101094

(51) Int. Cl. H01J 1/02; H01J 1/00

(52) U.S. Cl. 313/309; 313/311; 313/351; 313/495

(57) ABSTRACT

A field emission lighting device is disclosed in the present invention. The field emission lighting device includes a cathode, an isolating layer, a plurality of isolating emitter bases, a plurality of niobium emitter tips each formed on a respective emitter base, a light-permeable anode disposed opposite to the cathode, and a fluorescence layer formed on the anode. The isolating layer is formed on the cathode. The isolating emitter bases extend from the isolating layer. The isolating layer and the isolating emitter bases are comprised of diamond like carbon. The isolating emitter bases each include an electrically conductive connecting portion configured for establishing an electrically conductive connection between the emitter tip and the cathode.

### CROSS-REFERENCES TO RELATED APPLICATION

This application is related to a copending U.S. patent application filed on Jul. 29, 2005, entitled “FIELD EMISSION LIGHTING DEVICE”, and another copending U.S. patent application filed on Nov. 23, 2005, entitled “A BACKLIGHT DEVICE USING A FIELD EMISSION LIGHT SOURCE”, each having the same assignee as the instant application. The disclosures of the above-identified applications are incorporated herein by reference.

### FIELD OF THE INVENTION

The present invention relates to electronic lighting techniques, and more particularly to a field emission lighting device.

### DESCRIPTION OF RELATED ART

Conventional light sources generally include combustion-based light sources, incandescent light sources, and fluorescent light sources. The fluorescent light sources include for example, high-intensity discharge (HID) lamps, and light emitting diode (LED) lamps.

As regards a typical HID lamp, a low voltage has to be converted into a high voltage of about 2300V so as to excite an inert gas to thereby produce electric arc light. In operation, a constant working voltage of about 8000 V has to be maintained so as to keep the HID lamp lighting. Therefore, such HID lamp has to be equipped with a voltage converter. This increases power consumption and complexity of configuration of the HID lamp. Nowadays, the LED lamps have been widely used in small sized lamps. The LED lamps generally have low luminous.

Field emission devices operate based on emission of electrons in a vacuum. In operation, electrons are extracted from micron-sized emitter tips under a strong electric field. The electrons are accelerated under the electric field and then bombard a fluorescent material. The fluorescent material then emits visible light. Field emission devices are generally compact in size and light in weight, and are capable of providing a high brightness.

Nevertheless, all of the above-mentioned light sources have a common shortcoming that they cannot provide a high light brightness and uniformity. In order to achieve a higher uniform brightness using such lamps, a higher voltage or more light sources would have to be required. Therefore, energy consumption is undesirably increased accordingly.

What is needed, therefore, is a field emission lighting device that has a stable structure and a high uniform brightness luminous efficiency.

### SUMMARY OF INVENTION

A field emission lighting device includes a cathode, an isolating layer, a plurality of isolating emitter bases, a plurality of niobium emitter tips each formed on a respective emitter base, a light-permeable anode disposed opposite to the cathode, and a fluorescence layer formed on the anode. The isolating layer is formed on the cathode. The isolating emitter bases extend from the isolating layer. The isolating layer and the isolating emitter bases are comprised of diamond like carbon. The isolating emitter bases each include an electrically conductive connecting portion configured for establishing an electrically conductive connection between the emitter tip and the cathode.

The emitter bases and the isolating layer are advantageously configured as a whole. Further, each of the emitter bases and the isolating layer may cooperatively define a through hole, and the electrically conductive connecting portion is received therein.

The emitter tips each have a bottom portion and a top portion. The bottom portion has a cross-section size essentially equal to the cross-section size of the emitter base. The top portion has a cross-section size in the range from about 0.5 nanometers to about 10 nanometers. The emitter base and the respective emitter tip have a total height in the range from about 100 nanometers to about 2000 nanometers.

In addition, the field emission lighting device includes a lower substrate and a nucleation layer. The cathode is disposed on the lower substrate. The lower substrate is comprised of a material selected from the group consisting of Cu, Ag, Cu—Ag alloy, silicon, and glass. The nucleation layer is located between the cathode and the isolating layer and is comprised of silicon.

The combined emitter tip and the emitter base have good mechanical strength, and excellent field-emission capability. In addition, the isolating layer provides a stable substrate for supporting the emitter bases and the emitter tips, thereby enhancing stability thereof and increasing working lifetime thereof. As such, the combined emitter tip and the emitter base may operate under desired high voltage electrical fields without the risk of being damaged and thereby providing a high luminous efficiency and a satisfactory brightness at a long period of time.

The brightness provided by the present field emission lighting device may reach about 10 to about 1000 times that of a comparable light emitting diode (LED) or high intensity discharge (HID) lamp.

Other advantages and novel features of the embodiments will become more apparent from the following detailed description when taken in conjunction with the accompanying drawings.

### BRIEF DESCRIPTION OF DRAWINGS

Many aspects of the field emission lighting device can be better understood with reference to the following drawings. The components in the drawings are not necessarily to scale, the emphasis instead being placed upon clearly illustrating the principles of the present invention. Moreover, in the drawings, like reference numerals designate corresponding parts throughout the several views.

FIG. 1 is a schematic, cross-sectional view of a field emission lighting device in accordance with a first preferred embodiment of the present invention;

FIG. 2 is an enlarged view of an exemplary emitter unit of the field emission lighting device of FIG. 1;

FIG. 3 is schematic, cross-sectional view of a field emission lighting device in accordance with a second preferred embodiment of the present invention; and

FIG. 4 is an enlarged view of an exemplary emitter unit of the field emission lighting device of FIG. 3.

### DETAILED DESCRIPTION

Embodiments of the present invention will now be described in detail below and with reference to the drawings.

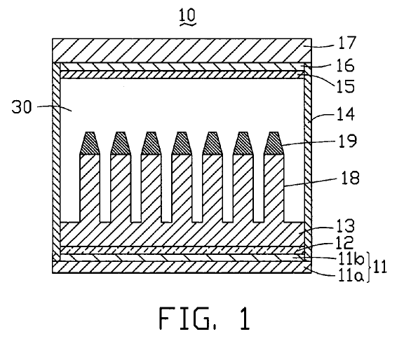

Referring to FIG. 1, this illustrates a field emission lighting device 10 in accordance with a first preferred embodiment of the present invention. The field emission lighting device 10 mainly includes a low substrate 11a, a cathode 11b, a nucleation layer 12, an isolating layer 13, a fluorescence layer 15, a light-permeable anode 16, a transparent upper substrate 17, a plurality of isolating emitter bases 18, and a plurality of emitter tips 19.

The nucleation layer 12 is located between the cathode 11b and the isolating layer 13. The isolating layer 13 is formed on the nucleation layer 12. The isolating emitter bases 18 are formed on the isolating layer 13. The emitter tips 19 each are formed on a respective isolating emitter base 18. The anode 16 is formed on an interior surface of the upper substrate 17. The fluorescence layer 15 is formed on the anode 16.

The cathode 11b is formed on the low substrate 11a. The cathode 11b and the low substrate 11a cooperatively form an integrated cathode plate 11. The cathode 11b is generally comprised of a material selected from the group consisting of copper (Cu), silver (Ag), and gold (Au). The low substrate 11a may be made of a metal such as Cu or Ag, or a metal alloy such as a Cu—Ag alloy. The low substrate 11a advantageously has a surface configured to be smooth and not prone to crack, for facilitating formation of the cathode 11b thereon.

The nucleation layer 12 preferably has a thickness of less than about 1 micrometer. The nucleation layer 12 is configured for facilitating deposition of the isolating layer 13 thereon. The nucleation layer 12 is advantageously comprised of a material selected from the group consisting of iron (Fe), cobalt (Co), nickel (Ni), and other suitable transition metals.

The isolating layer 13 preferably is comprised of a same material as the emitter bases, such as for example, diamond like carbon (DLC). The isolating layer 13 is formed by a method selected from the group consisting of a reactive sputtering method, a chemical vapor deposition method, a plasma-enhanced chemical vapor deposition method, an ion-beam sputtering method, a dual ion-beam sputtering method, and a glow discharge method.

The emitter tips 19 are beneficially comprised of niobium. The emitter bases 18 and the isolating layer 13 are advantageously integrally formed as a whole of the same material. Therefore, the isolating layer 13 provides a stable substrate for supporting the emitter bases 18 and the emitter tips 19. This configuration enhances stability of the overall structure of the emitter units and therefore increases working lifetime of the field emission lighting device 10.

In manufacture, a DLC layer is deposited on the nucleation layer 12. A niobium layer is deposited on the DLC layer. The niobium layer is then etched so as to form the emitter tips 18. The DLC layer is sequentially etched so as to form the emitter bases 19 on the isolating layer 13 with the emitter tips 18 being formed thereon. Namely, the non-etched portion of the DLC layer serves as the isolating layer 13.

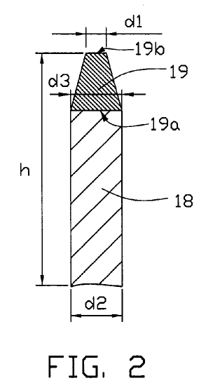

Referring to FIG. 2, each emitter base 18 and the respective emitter tip 19 cooperatively form an emitter assembly or an emitter unit for the field emission lighting device 10. The emitter bases 18 formed of DLC have many valuable characteristics, such as excellent mechanical strength, high hardness, high chemical stability, and high thermal conductivity. For example, the emitter bases 18 can effectively dissipate heat generated from the cathode 11b.

The emitter bases 18 can be configured to be cylindrical, conical, annular, parallelepiped-shaped, or other suitable configurations. The emitter bases 18 in a form of a cylinder have a diameter d2 in the range from about 10 nanometers to about 100 nanometers. Preferably, the diameter d2 is in the range from about 10 nanometers to about 50 nanometers.

The emitter tips 19 each are in a form of a frustum of a cone. The emitter tips 19 each include a bottom portion 19a and a top portion 19b. The bottom portion 19a has a diameter d3 approximately equal to the diameter d2 of the emitter base 18. The top portion 19b has a diameter d1 in the range from about 0.5 nanometers to about 10 nanometers. The emitter tips 19 each have an aspect ratio in the range from about 10 to about 200. The aspect ratio is preferably in the range from about 20 to about 100.

The emitter unit including the emitter base 18 and the respective emitter tip 19 has a total height h in the range from about 100 nanometers to about 2000 nanometers.

Referring back to FIG. 1, the upper substrate 17 is formed of a transparent material such as glass, plastic, or silicon oxide. The upper substrate 17 is generally a form of planar substrate.

A plurality of sidewalls 14 is interposed between the lower substrate 11a and the upper substrate 17. A chamber 30 is thereby bounded by the sidewalls 14, the lower substrate 11a and the upper substrate 17. The chamber 30 is advantageously evacuated to form a suitable level of vacuum (i.e., a level conducive to the free movement of electrons therethrough).

Alternatively, the upper substrate 17 can be configured as a tubular substrate. The cathode 11b may be a metal filament disposed between the sidewalls 14. The cathode 11b could be interposed between the sidewalls 14, and thereby obviating the need for using a lower substrate 11a for supporting the cathode 11b thereon. The cathode 11b would preferably extend along a central axis of the tubular substrate. The emitter base 18 and the emitter tip 19 would be formed on an outside surface of the cathode 11b. In fact, a field emission lighting device in this form would be a tubular light source.

The anode 16 is formed on the upper substrate 17 by a DC reactive sputtering technique or an RF reactive sputtering technique. The anode 16 is beneficially made of an indium tin oxide (ITO) material. The fluorescence layer 15 is formed on the anode 16 and is capable of producing color light after electron bombardment. The fluorescence layer 15 is generally made of a phosphor material.

In operation, a bias voltage is applied between the cathode 11b and the anode 16, thereby an electric field is established. Electrons are extracted from the emitter tip 19 and are accelerated and then bombard the fluorescence layer 15. As a result, the fluorescence layer 15 generates visible light after being bombarded by the electrons.

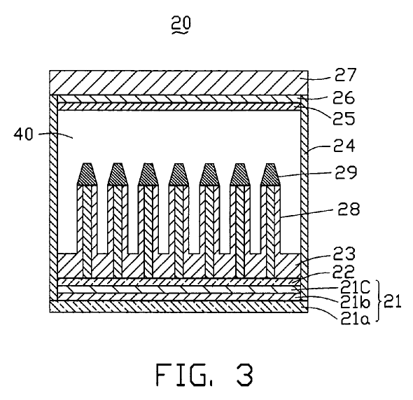

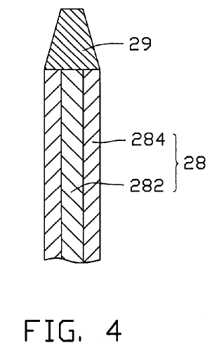

Referring to FIGS. 3 and 4, an alternative field emission lighting device 20 is illustrated in accordance with a second preferred embodiment of the present invention. The field emission lighting device 20 has essentially similar structures, sizes, and elements to the field emission lighting device 10. The field emission lighting device 20 mainly includes a low substrate 21a, a cathode 21b, an isolating layer 23, a fluorescence layer 25, a light-permeable anode 26, a transparent upper substrate 27, a plurality of isolating emitter bases 28 and emitter tips 29, a chamber 40, and a number of sidewalls 24.

In the illustrated embodiment, a functional layer 21c is formed on the cathode 21b. In general, the cathode 21b, which is made of the silver and the gold, has a relatively low mechanical strength. The functional layer 21c is advantageously comprised of a material having a relatively high mechanical strength, such as Cu, Al, and Cu—Al alloy. The functional layer 21c can effectively improve the mechanical strength of the cathode 21b. The low substrate 21a, the cathode 21b and the functional layer 21c cooperatively form a cathode plate 21.

The emitter base 28 of the second embodiment is similar to the isolating emitter base 28 of the first embodiment, except that a conductive core portion 282 is interposed between the cathode plate 21 and the emitter tip 29. An isolating enclosing portion 284 is provided surrounding the core portion 282 therein. The conductive core portion 282 extends through the isolating layer 23 and electrically interconnects the cathode 21b with the corresponding emitter tip 29. As such, the conductive core portion 282 provides an electrically conductive connection between the cathode plate 21 and the corresponding emitter tip 29.

In a process for manufacturing an emitter base 28, a through hole is defined in and through a preformed solid isolating enclosing portion 284 and the isolating layer 23. A conductive metal material, such as copper, gold, silver or their alloys, is then filled into the through hole of the isolating enclosing portion 284, thereby obtaining the emitter base 28 including the conductive core portion 282 and the isolating enclosing portion 284. Alternatively, the conductive metal material could be first selectively deposited to form the core portions 282 and then the material of the corresponding enclosing portions 284 and the isolating layer 23 could be deposited therearound, either selectively to the desired surrounding shape or subsequently etched or otherwise shaped to a desired outer configuration.

In addition, alternatively, the low substrate 21a could be made of a non-conductive material such as silicon or glass. Therefore, the low substrate 21a, the cathode 21b, and the functional layer 21c cooperatively form a cathode plate 21.

The field emission lighting device of the above-described preferred embodiments may be implemented into various illumination products. For example, the field emission lighting device may be employed as a headlight for an automobile.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A field emission lighting device comprising:
a cathode;
an isolating layer formed on the cathode, the isolating layer being comprised of diamond like carbon;
a plurality of isolating emitter bases extending from the isolating layer, the isolating emitter bases being comprised of diamond like carbon;
a plurality of niobium emitter tips each formed on a respective emitter base;
a light-permeable anode disposed opposite to the cathode; and
a fluorescence layer formed on the anode;
wherein the isolating emitter bases each comprising an electrically conductive connecting portion configured for establishing an electrically conductive connection between the emitter tip and the cathode.

2. The field emission lighting device of claim 1, wherein the emitter bases and the isolating layer are integrally formed as a whole.

3. The field emission lighting device of claim 1, wherein each of the emitter bases and the isolating layer cooperatively define a through hole, and the electrically conductive connecting portion is received therein.

4. The field emission lighting device of claim 1, further comprising a lower substrate being comprised of a material selected from the group consisting of Cu, Ag, Cu—Ag alloy, silicon, and glass.

5. The field emission lighting device of claim 1, further comprising a nucleation layer located between the cathode and the isolating layer.

6. The field emission lighting device of claim 1, further comprising a function layer formed on the cathode.

7. The field emission lighting device of claim 10, wherein the function layer is comprised of a material selected from the group consisting of Cu, Al, and Cu—Al alloy.

8. The field emission lighting device of claim 1, wherein the emitter bases each have a cross-section size in the range from about 10 nanometers to about 100 nanometers.

9. The field emission lighting device of claim 8, wherein the emitter tips each have a bottom portion having a cross-section size essentially equal to the cross-section size of the emitter base.

10. The field emission lighting device of claim 1, wherein the emitter tips each have a top portion having a cross-section size in the range from about 0.5 nanometers to about 10 nanometers.

11. The field emission lighting device of claim 1, wherein the emitter base and the respective emitter tip have a total height in the range from about 100 nanometers to about 2000 nanometers.
